(19) United States
(12) Patent Application Publication
(10) Pub. No.: US 2009/0139225 A1
(43) Pub. Date: Jun. 4, 2009

(54) HYDRAULIC INERTER MECHANISM

(75) Inventors: Fu-Cheng Wang, Taipei (TW); Tz-Chian Lin, Taipei (TW)

Correspondence Address: PEARNE & GORDON LLP, 1801 EAST 9TH STREET, SUITE 1200, CLEVELAND, OH, 44114-3108, US

(73) Assignee: NATIONAL TAIWAN UNIVERSITY, Taipei (TW)

(21) Appl. No.: 12/048,652

(22) Filed: Mar. 14, 2008

(30) Foreign Application Priority Data
Nov. 30, 2007 (TW) 096140535

(51) Int. Cl. F16D 31/02

(52) U.S. Cl. 60/469

(57) ABSTRACT

The invention provides a hydraulic inerter mechanism, including: a hydraulic cylinder; a hydraulic motor connected to the hydraulic cylinder, with an output shaft thereon for converting the motion of the hydraulic cylinder from rectilinear motion to rotary motion; and an inertia body disposed on the output shaft. In operation, an external force applied to the inerter mechanism causes displacement of the piston, thereby pushing working fluid inside the hydraulic cylinder to generate a pressure difference between an inlet and an outlet of a hydraulic motor. The differential pressure consequently drives the hydraulic motor to rotate, and then the output shaft further drives the inertia body to rotate, thereby attaining inerter characteristics.

### BACKGROUND OF THE INVENTION

1. Field of the Invention

This invention generally relates to inerter mechanisms, and, more specifically, to a hydraulic inerter mechanism.

2. Description of Related Art

Electro-mechanical system integration has become one of the most important areas of engineering field in the 21^{st} century. In such integration, it is often necessary to convert electrical characteristics into mechanical characteristics, or vice-versa. In conventional engineering applications, there are two analogies between the mechanical and electrical systems, namely the “force-current” analogy and the “force-voltage” analogy. For the force-current analogy, the physical characteristics of mass, damping and spring correspond to the electrical characteristics of capacitance, resistance and inductance, respectively. Also, for the force-voltage analogy, the physical characteristics of mass, damping, and spring correspond to the electrical characteristics of inductance, resistance, and capacitance, respectively.

It is noted that the above passive elements of electronic circuits are two-terminal elements. That is, the two terminals of resistors, inductors and capacitors are not restricted by specific reference points. However, the mass element fails to be a genuine two-terminal network element in that one terminal of the mass is always connected to the ground. Therefore, in order to compare a conventional mass element with an electrical element, the corresponding electrical element must have one terminal connected to the ground. Nevertheless, this requirement limits the freedom or flexibility in designing electro-mechanical systems. Furthermore, for decades the abundant electrical circuit theorems have been applied to mechanical systems for network analyses and syntheses. However, the imperfect analogy of mass elements has limited the achievable performance of passive mechanical networks. Therefore, it is necessary to propose a true two-terminal mechanical elements to substitute for the mass.

In view of this, WO 03/005142 A1 assigned to Cambridge University has disclosed the inerter theory in which an inerter mechanism, like the spring and damper, was proposed as a true two-terminal element. Therefore, by substituting the mass element in the conventional mechanical network systems with an inerter, a complete electrical/mechanical network analogy is obtained. Using this complete analogy, the abundant electrical network theorems can be applied to the design of mechanical systems, such as vehicle suspension systems, motorcycle steering control, train suspension systems, building isolation systems, and so on.

After the inerter theory was published, a practical design of rack-and-pinion inerter mechanism was developed. Referring to FIG. 1, the rack-and-pinion inerter mechanism includes a stand 10, a rack 11 physically allocated and sliding horizontally on the stand 10, a gear set 12 meshing with the rack 11, and a flywheel 13 connected to the gear set 12.

When an external force (as indicated by the arrow) is applied to one terminal of the rack 11, a relative displacement between the rack 11 and the stand 10 will cause the rack 11 to drive gears 121, 122, and 123 in the gear set 12 to rotate, which in turn causes the flywheel 13 to revolve, thereby converting the rectilinear motion of the rack 11 to rotary motion of the gear set 12. The rack-and-pinion inerter mechanism has two terminals, the rack 11 and the stand 10. And the formula F=b·a can be deduced from the motions, in which F is the force, a is the relative acceleration of the two terminals, and b is the inerter coefficient, called inertance, of the system. The inertance is obtained by calculating the radius and moment of inertia of each gear in the gear set and the moment of inertia of the flywheel. Therefore, an appropriate rack-and-pinion inerter mechanism can be designed by adjusting the gear set and the flywheel.

Although a rack-and-pinion inerter mechanism is easy to design and its materials are readily available, the backlash between gears might be serious. The backlash problem refers to two adjoint gears being temporarily incapable of effectively meshing with each other such that the two gears are not in effective contact with each other during rotation. For example, when the gears switch the direction of motion at high speed, backlash between gears will cause system delay or phase lag. Moreover, the gears of a rack-and-pinion inerter are likely to collapse when the mechanism is under large external load.

Accordingly, it is highly desirable in the industry to provide a low cost inerter mechanism that is capable of withstanding high loads and effectively solving the aforesaid backlash and load limitations of the prior art.

### SUMMARY OF THE INVENTION

In light of the shortcomings of the above prior arts, it is an objective of the invention to provide a hydraulic inerter mechanism for enhancing the correspondence between electrical networks and mechanical networks.

It is another objective of the invention to provide a hydraulic inerter mechanism for systems subjected to high external force loads.

It is another objective of the invention to provide a hydraulic inerter mechanism that can be assembled at low cost.

In accordance with the aforementioned objectives, the invention provides a hydraulic inerter mechanism, which comprises a hydraulic cylinder; a hydraulic motor connected to the hydraulic cylinder with an output shaft for converting the linear motion of the hydraulic cylinder to rotary motion; and an inertia body disposed on the output shaft.

According to the aforesaid structure, the hydraulic cylinder and the hydraulic motor further include working fluid therein, in which the hydraulic cylinder has a piston disposed inside the cylinder and a piston rod connected therewith and emerging externally. The piston divides the hydraulic cylinder into two compartments, wherein each compartment has a corresponding joint opening. The hydraulic motor has an inlet and an outlet, and the inlet and the outlet are connected to the joint openings of the hydraulic cylinder through pipe bodies, respectively, wherein each of the pipe bodies is connected to a manometer. Preferably, in application, the inertia body is a flywheel.

In the aforesaid structure, if an external force is applied to the piston rod, the piston is translated, and thus forces the working fluid inside the hydraulic cylinder to flow into the hydraulic motor through the connecting pipe. Then, the pressure difference between the inlet and the outlet of the hydraulic motor will drive it to revolve and further drive the inertia body to rotate about the output shaft, thereby attaining the inerter characteristics.

The use of hydraulic cylinders can sustain high external loads, and reduce backlash problems. Moreover, since the use of hydraulic cylinders is a well-known and well-developed technique in the industry, it is feasible to provide a low cost inerter mechanism to replace the gear mechanism of the prior art.

In addition, a vibration control system usually consists of damping components for dissipating energy. The hydraulic inerter mechanism of the invention provides damping effects, and thus can avoid adding such components. In summary, compared with the prior arts, the inerter mechanism of the invention can provide ideal inerter characteristics in a vibration system with high external loads and a high damping coefficient.

### BRIEF DESCRIPTION OF DRAWINGS

The present invention can be more fully understood by the following detailed description of the preferred embodiments, with reference made to the accompanying drawings, wherein:

FIG. 1 is a perspective diagram of a conventional inerter mechanism;

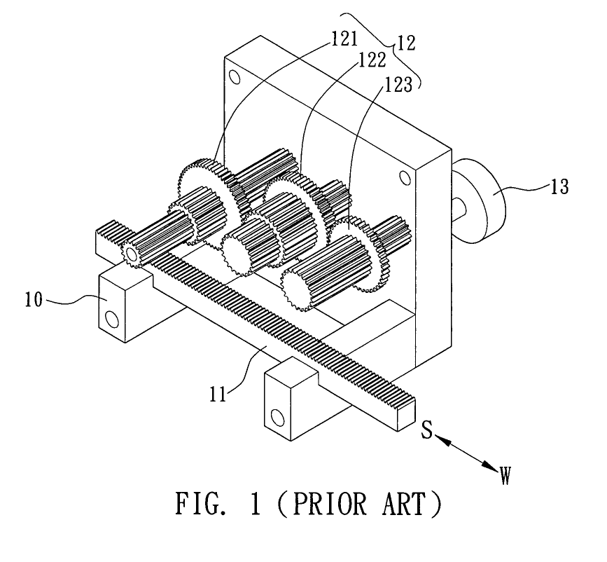

FIG. 2 is a perspective diagram of the hydraulic inerter mechanism of the invention;

FIG. 3 is a cross-sectional view of the hydraulic inerter mechanism of the invention;

FIG. 4 is a first 3-D deformation diagram of a flywheel of the inerter mechanism according to the invention, where the gear ratio and thus the inertance can be adjusted by the gear box; and

FIG. 5 is a second 3-D deformation diagram of a flywheel of the screw inerter mechanism according to the invention, where the inertance can be adjusted by relocation of masses.

### DETAILED DESCRIPTION OF THE PREFERRED EMBODIMENTS

The following embodiments are provided to illustrate the invention. Persons with ordinary skills in the art can easily appreciate the technical features and the achieved functions of the invention, although other implementations are possible.

### First Embodiment

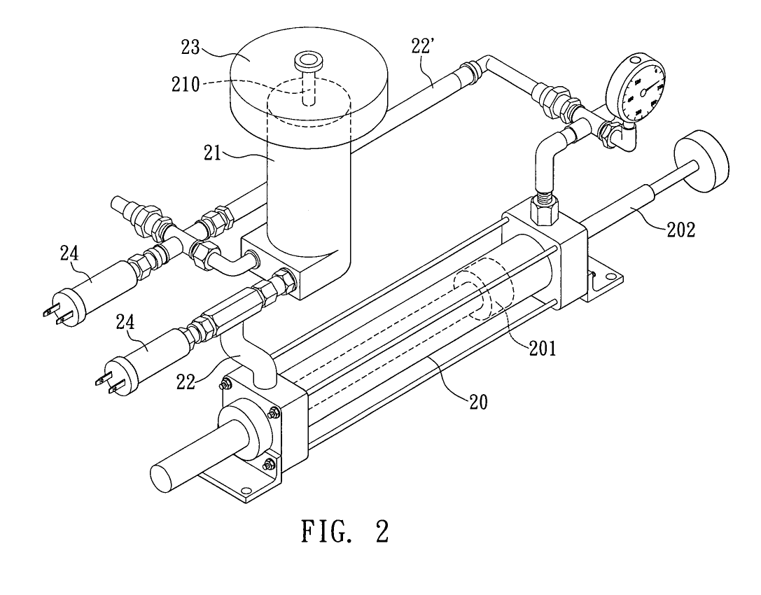

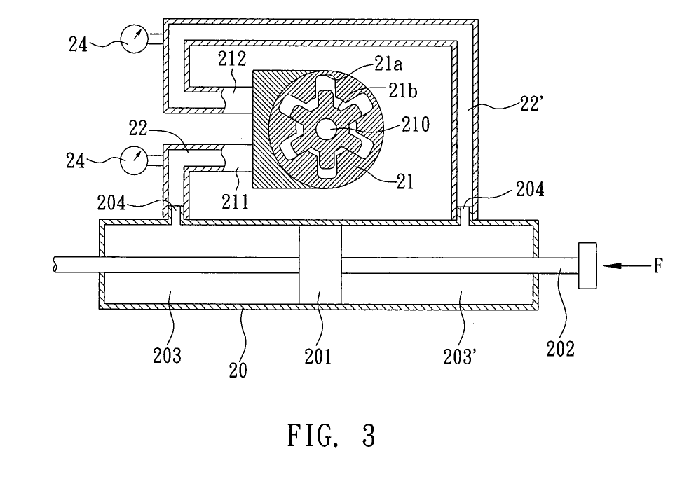

Referring to FIGS. 2 and 3, the invention provides a hydraulic inerter mechanism, comprising a hydraulic cylinder 20, a hydraulic motor 21 and an inertia body 23. The hydraulic cylinder 20 includes a piston 201 disposed inside the cylinder and a piston rod 202 connected therewith and emerging externally, wherein the piston 201 divides the hydraulic cylinder 20 into two compartments 203 and 203′, in which each compartment has a respective joint openings 204. The hydraulic motor 21 includes an output shaft 210, an inlet 211 and an outlet 212, wherein the inlet 211 and the outlet 212 are connected to the joint openings 204 of the hydraulic cylinder 20 through pipe bodies 22 and 22′, respectively. The inertia body 23 is preferably a flywheel and disposed on the output shaft 210.

In addition, the hydraulic cylinder 20 and hydraulic motor 21 include working fluid therein, as well as manometers 24 connected to the pipe bodies 22 and 22′. The manometers are used to measure pressure of the working fluid of the hydraulic cylinder 20 at the inlet 211 and the outlet 212. When an external force is applied to the inerter mechanism, the piston is moved such that and the working fluid inside the hydraulic cylinder 20 is pressurized to cause a pressure difference between the inlet 211 and the outlet 212. In the case that the force is exerted so as to cause the piston rod 202 connected with the piston 201 to move further into the cylinder 20, the pipe bodies 22 and 22′ guide the working fluid inside compartment 203 into the hydraulic motor 21, which consequently forces the working fluid inside the hydraulic motor 21 to be guided into compartment 203′ of the hydraulic cylinder 20.

It is noteworthy that the aforesaid hydraulic cylinder 20 has the advantages, such as taking heavy loads and is also characterized by low production costs. Also, it can work simultaneously as a liquid damper, and therefore, the hydraulic cylinder 20 has the characteristics of both an inerter and a hydraulic damper.

Moreover, the hydraulic motor 21 is a gear rotor hydraulic motor including a set of cycloidal gears, which has an outer gear 21a fixed to a shell body of the hydraulic motor 21 and an inner gear 21b that runs inside the outer gear 21a. Further, the centers of the outer gear 21a and the inner gear 21b are eccentric. Since the inner and outer gears have sliding contacts, the mechanical friction is low. In addition, the hydraulic motor has lower static friction, and is suitable for applications involving high revolving speed and low torque.

Referring to FIG. 3, an external force F is applied to one end of the piston rod 202 for pushing the piston 201 inwards to create rectilinear motion inside the hydraulic cylinder 20, thus increasing the pressure of the working fluid inside compartment 203 to the inlet 211 of the hydraulic motor 21 through pipe body 22 and thereby forming a high pressure zone at the inlet 211 of the hydraulic motor 21. Then, the working liquid flows from the outlet 212 back to compartment 203′ of the hydraulic cylinder 20 through pipe body 22′, thereby forming a low pressure zone at outlet 212 of the hydraulic motor 21. Consequently, a pressure difference is formed between the inlet 211 and the outlet 212 of the hydraulic motor 21, wherein such a pressure difference can be calculated from difference of the readings of the two manometers 24. The pressure difference is capable of driving the hydraulic motor 21 to revolve, and thus drives the output shaft 210, so as to drive the inertia body 23 to rotate. Consequently, the rectilinear motion is converted to rotary motion, and the external force is converted to rotate the flywheel, thereby attaining inerter characteristics. Moreover, if the external force is applied to the opposite end of the piston rod 202, the piston moves in an opposite direction and the hydraulic motor 21 rotates reversely, thereby being a reversible process.

Further, for an ideal inerter, system inertance b can be calculated as follows.

b=I×(A/D)²

in which I is the inertia of the flywheel, A is the area of the piston, and D is a constant, and

Q=D×ω,

wherein Q is the flow rate through the hydraulic cylinder, and ω is the angular velocity of the motor. If the system nonlinearities are considered, system inertance can be derived as:

$$b = I \times {( A / D )}^{2} \times \frac{{η}_{v}}{{η}_{m}}$$

in which η_{ν} is the volumetric efficiency of the motor, and ηₘ is the mechanical efficiency of the motor. It is noted that η_{ν}<1 and ηₘ<1.

It would be realized from the experimental data shown in the table below that the original mass of the inertia body 23 was low, but the inertance of the system was far larger than the original weight of body 23, thereby attaining inerter characteristics and allowing the hydraulic inerter mechanism to take extremely heavy loads.

| Flywheel Mass (kg) | Inertance (kg) |
|---|---|
| 0.35 | 668 |
| 0.26 | 281 |
| 0.13 | 108 |

Moreover, since the inertance of the inerter mechanism of the invention is changeable by adjusting the moment of inertia of the inertia body, the moment of inertia of the inertia body can be adjusted by changing the mass m of inertia body or the distance r between the masses comprising the inertia body and the center of the rotating shaft. The formula for the moment of inertia is shown below.

$$I = {\sum }_{i = 1}^{N} {m}_{i} {r}_{i}^{2} ,$$

wherein mᵢ is the mass of particle i, and rᵢ is the distance between particle i and the rotation shaft. The moment of inertia of a multi-particle inertia body is the sum of each particle mass multiplied by the square of distance between each particle and the rotating shaft. Therefore, changing the mass of each particle of the inertia body or the distance between particles and the rotation shaft will change moment of inertia of the inertia body, and consequently will change the inertance of the inerter mechanism. The following two embodiments are examples of changing the mass of particles of the inertia body or the distance between particles of inertia body and the rotation shaft, thereby changing the moment of inertia of an inertia body.

### Second Embodiment

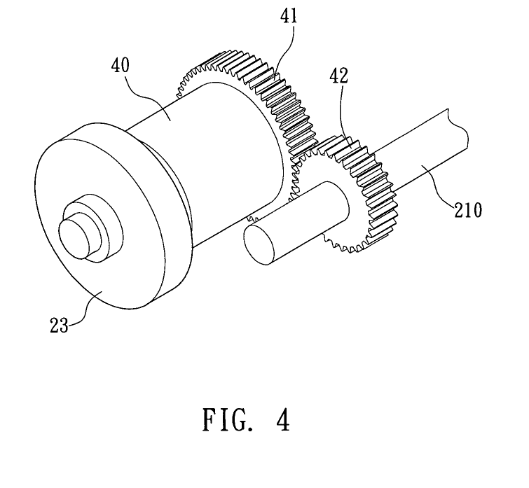

Referring to FIG. 4, the embodiment differs from the first embodiment only in the connection between the output shaft 210 and the inertia body 23. The other parts of design of the hydraulic inerter mechanism, such as the hydraulic cylinder 20, the hydraulic motor 21, the pipe bodies 22 and 22′ and the manometers 24, are substantially or completely the same, and therefore the followings are descriptions of the differentiated features only.

As shown in FIG. 4, the inertia body 23 is disposed and fixed onto a gear box 40 with gear set therein (not shown in the figure). One end of the gear box 40 is externally connected to the inertia body 23, and the other end is externally connected to a drive gear 41. An initiative gear 42 is disposed and fixed onto the output shaft 210 of the hydraulic motor 21. The drive gear 41 and the initiative gear 42 are in mesh, thereby forming a mechanical connection between the output shaft 210 and the inertia body 23. When the hydraulic motor 21 drives the output shaft 210, the initiative gear 42 is driven to revolve and the initiative gear 42 simultaneously drives the drive gear 41 to rotate. This further drives the gear set inside the gear box 40 to drive the inertia body 23 to revolve.

In the embodiment, the gear ratio α of the gear set is selected to change the system inertance as

b′=b·α²,

wherein b′ is the system inertance with the gear box, and b is the original system inertance when the gear ratio α=1, which includes the effects of the moment of inertia of the speed change gear set, the drive gear 41, and the initiative gear 42 on the system inertance, thereby adjusting the system inertance.

Therefore, the inertance of the hydraulic inerter mechanism can be adjusted by changing the gear ratio of the gear set.

### Third Embodiment

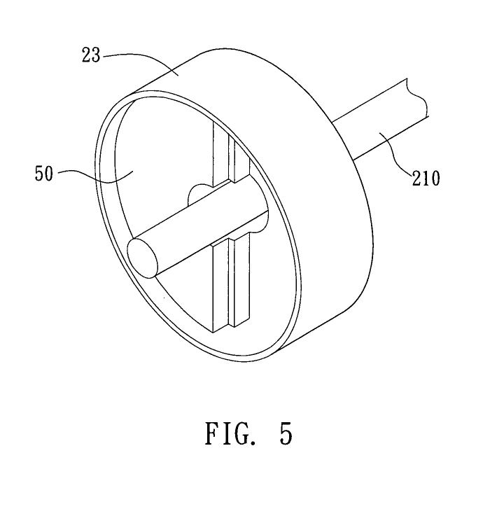

Referring to FIG. 5, the only difference between the embodiment and the first embodiment is the modification of the structure of the inertia body 23. The other parts of the design of hydraulic inerter mechanism, such as the hydraulic cylinder 20, the hydraulic motor 21, the pipe bodies 22 and 22′, and the manometers 24 are mostly or completely the same as in the first embodiment, and, therefore the following descriptions are of the differing features only.

As shown in FIG. 5, the inertia body 23 has at least a mass block 50 therein. The mass block 50 is used to adjust the moment of inertia of the inertia body 23 disposed and fixed onto the output shaft 210 of the hydraulic motor 21. When the hydraulic motor 21 drives the output shaft 210, it simultaneously drives the inertia body 23 to revolve. Therefore, by adding in at least a mass block 50 to adjust the moment of inertia of the inertia body 23, the inertance of the hydraulic inerter mechanism is adjusted accordingly.

Based on the above, in the hydraulic inerter mechanism of the invention, by applying force to one end of the piston rod, the hydraulic cylinder drives the hydraulic motor to rotate, and to drive the inertia body, such as a flywheel, and thereby being capable of taking heavy external loads. Moreover, the components applied to the hydraulic inerter mechanism are of low cost. Therefore, production cost of the hydraulic inerter mechanism is lowered in the invention.

Accordingly, in the hydraulic inerter mechanism of the invention, if a non-zero external force is applied to the piston rod, the piston is pushed and thus forces the working fluid of the hydraulic cylinder to flow into the hydraulic motor through connecting pipes, and consequently a pressure difference is created. Then, the pressure difference drives the hydraulic motor to revolve, and further drives the inertia body to rotate, thereby attaining the inerter characteristics. Since hydraulic technique is well-known, it can be applied to replace the rack-and-pinion inerter with a hydraulic system, which can take large external load at low production cost. Besides, vibration systems usually include energy-dissipating components, such as dampers. Nevertheless, friction of the inerter mechanism can be neglected when applied to systems with heavy loads in the invention. Therefore, the inerter mechanism of the invention becomes an ideal inerter mechanism in a vibration system with a high damping coefficient, and consequently increases the degree of correspondence between electrical and mechanical networks.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

What is claimed is:

1. A hydraulic inerter mechanism, comprising:
a hydraulic cylinder;
a hydraulic motor connected to the hydraulic cylinder and having an output shaft for converting the motion of the hydraulic cylinder from rectilinear motion to rotary motion; and
an inertia body disposed on the output shaft.

2. The hydraulic inerter mechanism of claim 1, further comprising working fluid sealed inside the hydraulic cylinder and the hydraulic motor.

3. The hydraulic inerter mechanism of claim 1, wherein the hydraulic cylinder has a piston disposed inside the cylinder and a piston rod connected therewith and emerging externally, and the piston divides the hydraulic cylinder into two compartments in which each of the compartments has a separate joint opening.

4. The hydraulic inerter mechanism of claim 3, wherein the hydraulic motor has an inlet and an outlet, and the inlet and the outlet are connected to the joint openings through pipe bodies, respectively.

5. The hydraulic inerter mechanism of claim 4, further comprising manometers connected to the pipe bodies.

6. The hydraulic inerter mechanism of claim 1, wherein the inertia body is adjustable.

7. The hydraulic inerter mechanism of claim 6, wherein the inertia body further comprises a plurality of mass blocks, wherein each of mass blocks rotates around the axle center and has adjustable mass and rotation radius.

8. The hydraulic inerter mechanism of claim 6, wherein the inertia body is disposed and fixed onto a gear box with a gear set therein.

9. The hydraulic inerter mechanism of claim 1, wherein the inertia body is a flywheel.

10. The hydraulic inerter mechanism of claim 1, wherein the hydraulic motor is a gear rotor hydraulic motor consisting of a set of cycloidal gears having an outer gear fixed to a shell body of the hydraulic motor and an inner gear running inside the outer gear.

11. The hydraulic inerter mechanism of claim 10, wherein the centers of the outer gear and the inner gear are eccentric.
